(19) United States
(12) Patent Application Publication
(10) Pub. No.: US 2013/0159454 A1
(43) Pub. Date: Jun. 20, 2013

(54) CUSTOMIZING DISTRIBUTION OF DATA FROM A SENSOR NETWORK DATA

(71) Applicants: James M. Hunter, San Jose, CA (US); Nathan Williams, San Jose, CA (US); Cedar Milazzo, San Jose, CA (US)

(72) Inventors: James M. Hunter, San Jose, CA (US); Nathan Williams, San Jose, CA (US); Cedar Milazzo, San Jose, CA (US)

(73) Assignee: MOTOROLA MOBILITY, INC., Libertyville, IL (US)

(21) Appl. No.: 13/328,143

(22) Filed: Dec. 16, 2011

(51) Int. Cl. G06F 15/16

(52) U.S. Cl. 709/217

(57) ABSTRACT

Distribution of data captured from a location by a sensor network based on selected distribution settings is disclosed. Data describing usage of one or more items at a location is received from a sensor network associated with the location. A sensor data distribution setting identifying a subset of the data from the sensor network and identifying a server associated with the subset is received. Responsive to the sensor data distribution setting, the subset of data is transmitted to the server associated with the subset without transmitting data from the sensor network data not included in the subset.

### FIELD OF THE DISCLOSURE

The present disclosure relates generally to distribution of data captured by a sensor network, and more specifically to customizing distribution of data from the sensor network while maintaining sensor network data security.

### BACKGROUND

Advances in network connectivity and computing capabilities have simplified the ability to capture data from various types of sensors. As sensors have become smaller and more power efficient, an increasing amount of data may be captured. For example, sensors now allow capture of data describing power usage for a variety of items or the cost of operating a device or appliance. Further advances will likely enable sensors to capture a wider range of data.

Additionally, third-party providers have an interest in obtaining information describing lifestyle or usage habits of potential customers. This information allows a third-party provider to tailor products or services offered to different customers, increasing the likelihood of the customer purchasing a product or service or viewing content provided by the third-party provider. As data captured by sensors provides data relevant to a customer's product usage habits or lifestyle, communicating this sensor data to a third-party provider enables the third party provider to more accurately identify likely interests of the user. Additionally, receiving sensor data from a variety of customers allows the third-party provider with a wealth of information to refine subsequent product or service offerings or tailoring advertising campaigns based on usage habits. Because of the value of this sensor data, third party providers may provide customers with incentives to share sensor network data, such as providing discounted products to customers sharing sensor data with the third-party provider. This may allow sensor data to be used as a currency that a customer provides to a third-party provider in exchange for a benefit, such as discounted offerings of products or services or advance offerings of products or services.

While data captured by sensors may be useful to a third-party provider, freely transmitting data from sensors to a third-party may intrude into a consumer's privacy by transmitting information that the consumer whishes to remain private or transmitting information to destinations the consumer does not wish to receive data. Additionally, consumers may be unwilling to transmit unsolicited sensor data to a third-party.

### BRIEF DESCRIPTION OF THE DRAWINGS

The accompanying Figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a computing architecture in accordance with some embodiments.

FIG. 2 is a block diagram of a sensor data distribution server in accordance with some embodiments.

FIG. 3 is an event diagram of a method for transmitting data captured by a sensor network describing item usage based on one or more sensor data distribution settings in accordance with some embodiments.

FIG. 4 is an event diagram of an alternative method for transmitting data captured by a sensor network describing item usage based on one or more sensor data distribution settings in accordance with some embodiments.

FIG. 5 is a flow chart of a method for selecting a sensor data distribution setting in accordance with some embodiments.

Skilled artisans will appreciate that elements in the Figures are illustrated for simplicity and clarity and have not necessarily been drawn to scale. For example, the dimensions of some of the elements in the Figures may be exaggerated relative to other elements to help to improve understanding of embodiments of the present invention.

The apparatus and method components have been represented where appropriate by conventional symbols in the drawings, showing the specific details that are pertinent to understanding the embodiments of the present invention so as not to obscure the disclosure with details that will be readily apparent to those of ordinary skill in the art having the benefit of the description herein.

### DETAILED DESCRIPTION

The following disclosure describes a system and method for using a sensor data distribution setting to transmit data captured by a sensor network. Data describing usage of one or more items at a location is received from a sensor network associated with the location. A sensor data distribution setting identifying a subset of the data from the sensor network and identifying a server associated with the subset is received. Responsive to the sensor data distribution setting, the subset of data is transmitted to the server associated with the subset without transmitting data from the sensor network data not included in the subset.

In the following description, for purposes of explanation, numerous specific details are set forth to provide a thorough understanding of the invention. However, it will be apparent to one skilled in the art that the invention can be practiced without these specific details. In other instances, structures and devices are shown in block diagram form in order to avoid obscuring the invention.

### System Overview

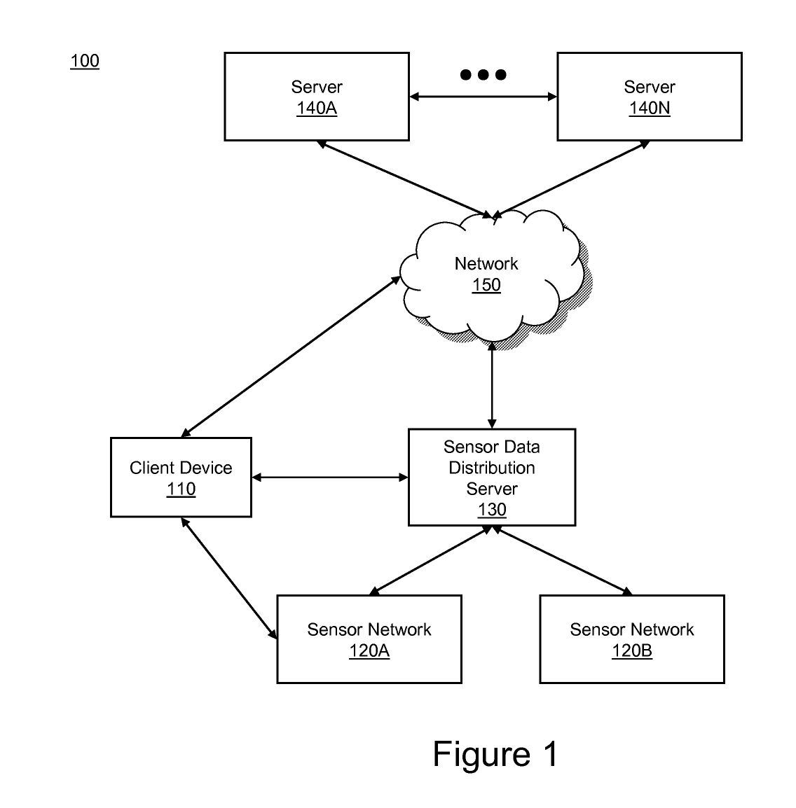

FIG. 1 is a block diagram of one embodiment of a computing architecture 100. In the embodiment shown by FIG. 1, the computing architecture 100 includes a client device 110 (also referred to herein individually and collectively using reference number 110), one or more sensor networks 120A, 120B (also referred to herein individually and collectively using reference number 120), a sensor data distribution server 130, one or more servers 140A, 140N (also referred to herein individually and collectively using reference number 140) and a network 150. However, in different embodiments, the computing architecture 100 may include different and/or additional components than those depicted in FIG. 1.

The client device 110 is any device with data processing and data communication capabilities. Examples of a client device 110 include a smartphone, a tablet computer, a netbook computer, a laptop computer or any other suitable device. The client device 110 receives data from one or more servers 140A, 140N via a network 150. In one embodiment, the client device 110 executes one or more applications exchanging data with one or more servers 140A, 140N and/or with the sensor data distribution server 130. For example, the client device 110 executes an electronic mail (e-mail) client application exchanging data associated with one or more e-mail accounts with a server 140. In an additional example, the client device 110 executes a social networking application receiving social network data associated with an account from a server 140 and/or transmitting social network data associated with the account to the server 140. As another example, one or more applications executed by the client device 110 receive one or more of video, audio, image and/or text data from a server 140 and present the received data to a user.

Additionally, the client device 110 is communicatively coupled to one or more of the sensor network 120, the sensor data distribution server 130 and/or one or more servers 140A, 140N. In one embodiment, the client device 110 is directly connected to the sensor network 120 and to the sensor data distribution server 130. The client device 110 is also connected to one or more servers 140A, 140N via a network 150. Alternatively, a client device 110 is connected to a sensor network 120, to the sensor data distribution server 130 and to one or more servers 140A, 140N using the network 150. However, in various embodiments, the client device 110 uses any suitable connection type or combination of communication types for coupling with other components of the computing architecture 100.

In one embodiment, the client device 110 is associated with an account, such as a user account, and includes an account identifier associated with the account. Different client devices 110 may be associated with different accounts or a single account may be associated with multiple client devices 110. In an embodiment, the client device 110 is associated with multiple accounts. For example, the client device 110 includes multiple account identifiers, allowing different users to share the client device 110.

A sensor network 120 comprises one or more sensors associated with a location and capturing data about one or more items at the location. As used herein, an item is a physical entity included at the location. Examples of an item include electronic devices, appliances, consumer items or other physical entities associated with identifying information. The sensor network 120 may include different types of sensors coupled to a computing device and/or a storage device. For example, the sensor network 120 includes a first sensor capturing data describing the frequency with which an item is used, a second sensor capturing power consumption by the item, a third sensor capturing power efficiency of the item, a sensor capturing item health and/or additional sensors capturing or calculating any suitable metric of item usage.

Multiple sensor networks 120A, 120B may be associated with the location, increasing the type and quantity of data describing usage of items at the location or interaction with the location itself. In one embodiment, different sensor networks 120A, 120B capture different types of data. For example, a first sensor network 120A may capture data describing power consumption of electronic devices at the location while a second sensor network 120B captures data from a security system, such as data from motion sensors.

In one embodiment, the sensor network 120 includes one or more sensors capturing data identifying an item. For example, a sensor in the sensor network 120 captures data associated with the item from a barcode associated with the item, a radio frequency identification tag attached to the item, a near field communication transceiver associated with the item or from any suitable source affixed to, packaged with or included on the item. In one embodiment, one or more sensors in the sensor network 120 capture data describing attributes or properties of location, such as a temperature, a time, an altitude, a humidity or other suitable data.

A sensor identifier is associated a sensor included in a sensor network 120, allowing identification of individual sensors or groups of sensors. In one embodiment, a metatag is also associated with a sensor in a sensor network 120. A metatag is information describing a classification of a sensor. For example, a metatag may identify a physical location of a sensor, a type associated with the sensor, a device associated with a sensor, a use associated with an item associated with a sensor, a description of an item associated with the sensor. However, a metatag may comprise any suitable information for identifying a sensor. Additional examples of metatags may be found in U.S. Pat. No. 7,953,678, which is hereby incorporated by reference herein in its entirety.

In one embodiment, sensors in the sensor network 120 also exchange data with each other. Hence, the sensor network 120 is associated with a location and captures data describing usage of one or more items at the location, data describing items at the location and/or data describing the location. For example, the sensor network 120 is associated with a home and includes sensors capturing data describing power usage by appliances within the home, a time when an appliance is used, an identifier of an item retrieved from an appliance, a time when the item was retrieved from the appliance, frequency of usage of an appliance or device, frequency with which an item is retrieved from an appliance and/or other data describing usage of items within the house.

Sensors within the sensor network 120 may be associated with a region of the location, allowing the sensor network 120 to include groups of sensors associated with regions of the location. In one embodiment, a metatag associated with sensors in the location is used to associate sensors with a region; for example, sensors associated with a metatag of “living room” are associated with the same region of the location. For example, if the sensor network 120 is associated with a home, a first group of sensors is associated with a living room, a second group of sensors is associated with a kitchen and a third group of sensors is associated with a bathroom. In one embodiment, sensor identifiers are associated with a region identifier, such as a metatag, to identify sensors associated with the region corresponding to the region identifier. This allows the sensor network 120 to identify regions within the location from which data is captured.

In one embodiment, a sensor network 120 also includes a processor determining additional usage information from data captured by the sensors. For example, the processor calculates a cost of operating an item from the item's power consumption, calculates a power cost associated with the location associated with the sensor network 120 and/or estimates a cost of future operation of the item based on frequency of use, power consumption of the item and power cost associated with the location including the sensor network 120. As another example, the processor in the sensor network 120 aggregates item usage or item resource usage from multiple items based on one or more item attributes. For example, the processor aggregates usage data of multiple items based on the region within the location associated with the sensor network 120 including the items or based on a type associated with an item.

A sensor network 120 is also associated with an account and communicates data captured by the one or more sensors, along with an account identifier and/or a location identifier, to the sensor data distribution server 130. In one embodiment, one or more sensors included in the sensor network 120, or a processor included in the sensor network 120, include an account identifier in a storage device to specify an account associated with the sensor network 120. A sensor, or a processor included in the sensor network 120, may include a location identifier, such as a metatag, associated with the location including the sensor network 120. In one embodiment, the sensor network 120 communicates the captured data to the sensor data distribution server 130 via the network 150. This allows the sensor data distribution server 130 to store data describing item usage and/or other data from the location associated with the sensor network 120 and/or other properties of the location associated with the sensor network 120.

The sensor data distribution server 130 is one or more computing devices having data processing and data communication capabilities. The sensor data distribution server 130 is communicatively coupled to the client device and to one or more sensor networks 120A, 120B. In various embodiments, the sensor data distribution server 130 uses one or more of a connection to a network 150 and/or one or more direct connections for coupling to a client device 110 and to a sensor network 120. The sensor data distribution server 130 is also coupled to one or more servers 140A, 140N via the network 150.

The sensor data distribution server 130 receives data from one or more sensor networks 120A, 120B and associates the received data with an account and/or with a location. In one embodiment, the sensor data distribution server 130 also applies one or more rules to received sensor network data to analyze the sensor network data. In one embodiment, the sensor data distribution server 130 may generate a value derived from sensor network data received from different sensors. For example, the sensor data distribution server 130 may apply one or more logical operators to sensor network data and store the result of the logical operator application. As a more specific example, the sensor data distribution server 130 may generate a value indicating that a person is in a region of the location associated with the sensor network 120 if two or more of the following occur: a motion sensor associated with the region detects motion, a radio frequency sensor associated with the region detects a signal or a sensor associated with an electronic device in the region captures an input. This allows the sensor network data distribution server 130 to describe additional interactions with the location by combining data from different sensors. In one embodiment, the sensor data distribution server 130 generates values from previously stored sensor network data to describe prior interactions with the location or to describe historical trends in item usage or location interaction form the stored sensor network data.

In one embodiment, the sensor data distribution server 130 also receives and stores one or more sensor data distribution settings from a client device 110. A sensor data distribution setting identifies a subset of the sensor data and associates a server 140 with the subset of the sensor data. For example, a sensor data distribution setting associates one or more sensor identifiers with a server 140, associates sensor network data captured during a time interval with a server 140 and/or associates sensor network data captured from sensors associated with a region within the location with a server 140.

Based on the one or more sensor data distribution settings, the sensor data distribution server 130 selects a subset of the data from a sensor network 120 and transmits the subset to the server 140 associated with the subset. Hence, the sensor data distribution settings customize the data from the sensor network 120 transmitted to a server 140 as well as specify one or more servers 140A, 140N receiving the sensor network data or a subset of the sensor network data. Responsive to a sensor data distribution setting, the sensor data distribution server 130 transmits a subset of the sensor network data to the server 140 associated with the subset by the sensor distribution setting. The sensor data distribution server 130 may transmit values derived from the sensor network data, as further described above, to the identified server 140. In one embodiment, the values derived from the sensor network data are transmitted in place of the sensor network data, providing the server 140 with data describing interaction with items at the location without sharing the sensor network data itself with the server 140.

However, the sensor data distribution server 130 does not transmit sensor network data other than the subset identified by the sensor data distribution setting to the server 140 associated with the subset by the sensor data distribution setting. Hence, the server 140 receives a limited amount of sensor network data identified by the sensor data distribution setting, while the sensor data distribution server 130 securely stores the remaining sensor network data. Thus, one or more sensor data distribution settings allow a user associated with the account to customize data from the sensor network 120 transmitted to a server 140. Additionally, different sensor data distribution settings may be associated with a sensor network 120, allowing different subsets of the sensor network data to be transmitted to different servers 140A, 140N. For example, a first sensor data distribution setting identifies a first subset of sensor network data for transmission to a first server 140A while a second sensor data distribution setting identifies a second subset of sensor network data for transmission to a second server 140N. This allows multiple subsets of sensor network data to be identified and transmitted to multiple servers 140A, 140N, customizing the sensor network data received by different servers 140A, 140N.

In one embodiment, the sensor data distribution server 130 also includes one or more data exchange settings describing data received by the account or location associated with the sensor network 120 from a server 140 responsive to the server 140 receiving sensor network data from the location. For example, a third-party provider associated with a server 140 may provide one or more incentives for the account associated with the sensor network 120 to transmit sensor network data to the server 140. The sensor data distribution server 130 may store data identifying the server 140, a description of content or data from the server 140 and sensor data for transmission to the server 140. In one embodiment, the content or data transmitted from the server 140 to the account is proportional to the amount of sensor network data transmitted to the server 140. For example, a third-party provider may transmit 10 coupons from the server 140 to a client device 110 responsive to receiving sensor network data from a first region of the location and may transmit 25 coupons to the client device 110 responsive to receiving sensor network data from the first region of the location and from the second region of the location. This allows a third-party associated with the server 140 to obtain additional sensor network data while allowing the account or location associated with the sensor network 120 to receive a benefit in exchange for transmitting the additional sensor network data to the server 140.

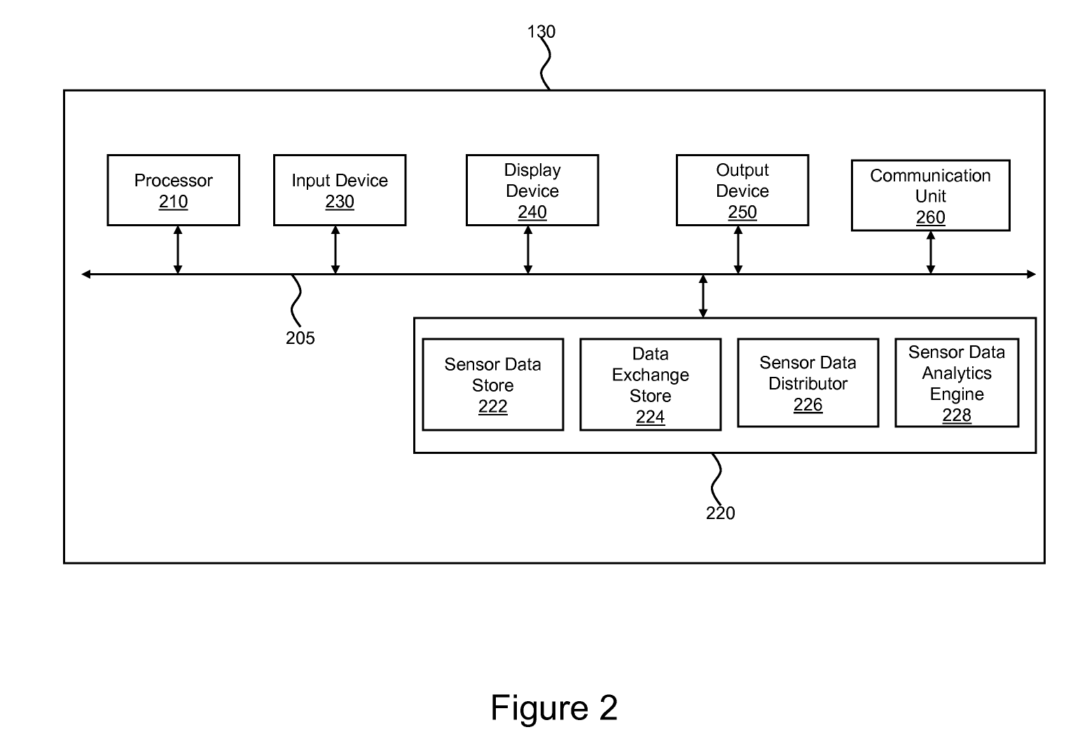

Hence, the sensor data distribution server 130 stores sensor network data and transmits a subset of the sensor network data to a specific server 140 identified by a sensor data distribution setting. The sensor data distribution server 130 allows sensor network distribution settings to be stored in a location accessible from different client devices 110 or from a remote location, simplifying modification of a sensor network distribution setting. Additionally, the sensor data distribution server 130 simplifies customization of the sensor network data to servers 140 by providing a central repository for retrieving sensor network data. By using the sensor data distribution server 130 to transmit sensor network data to one or more servers 140, sensor data distribution settings allow preservation of the privacy of the sensor network data while allowing selected sensor network data to be transmitted. The sensor data distribution server 130 is further described below in conjunction with FIG. 2.

Servers 140A, 140N are computing devices having data processing and data communication capabilities that exchange data and/or content with the sensor data distribution server 130 via the network 150. In one embodiment, one or more of the servers 140A, 140N are also coupled to a client device 110 via the network 150. For example, a server 140 transmits data such as a web page, audio content, video content, e-mail, calendar information, social networking data or other content via the network 150 to the sensor data distribution server 130. In one embodiment, a server 140 transmits one or more advertisements, coupons, product offers or other data to a client device 110.

A server 140 may associate metadata with transmitted content. Examples of metadata include a title, a keyword, a manufacturer identifier or any other information describing an attribute of the content. In one embodiment, the server 140 compares metadata associated with content to stored, or received, data to identify the content transmitted to a client device 110 or to the sensor data distribution server 130.

In one embodiment, a first server 140A acts as a liaison server between the sensor data distribution server 130 and one or more additional servers 140, also referred to as content servers 140N. For example, the first server 140A receives sensor data distribution settings from a client device 110 and receives sensor network data and/or values derived from the sensor network data from the sensor data distribution server 130. The first server 140A then transmits a subset of the sensor network data and/or values derived from the sensor network data to a second server 140B identified by a sensor data distribution setting. For example, the sensor data distribution server 130 transmits sensor network data and values derived from the sensor network data, as well as an account identifier or a location identifier, to the first server 140A. A sensor data distribution setting associated with the account identifier or location identifier is retrieved by the first server 140A and a second server 140B is identified from the sensor data distribution setting. The first server 140A then transmits a subset of the sensor network data and/or values derived from the sensor network data to the second server 140N via the network 150 or via a direct connection. In this embodiment, the sensor data distribution server 130 stores and analyzes the sensor network data while the first server 140A distributes subsets of the sensor network data to one or more additional servers using stored sensor data distribution settings.

The network 150 is a conventional type for data, video and/or audio transmission. In various embodiments, the network 150 is a wired network, a wireless network or a combination of wireless and wired networks. The network 150 may comprise a local area network (LAN), a wide area network (WAN) (e.g., the Internet), and/or any other interconnected data path across which multiple devices may communicate. The network 150 may be implemented in a variety of configurations, such as satellite link, wireless broadcast links and/or any other suitable configuration. A network 150 may have any number of configurations, such as a star configuration, a token ring configuration or another configuration known in the art. In yet another embodiment, the network 150 may be a peer-to-peer network.

The network 150 may also be coupled to or include portions of a telecommunications network for sending data in a variety of different communication protocols, such as those used for transmission control protocol/Internet protocol (TCP/IP), satellite link and/or cable television communication. For example, the network 150 may transmit voice data using one or more of a Global System for Mobile (GSM) communication system, a Code Division Multiple Access (CDMA) system, a Universal Mobile Telecommunications System (UMTS) or any other suitable protocols. The network 150 may also transmit data using one or more of General Packet Radio Service (GPRS), second-generation (2G), or greater, mobile network, third-generation (3G), or greater, mobile network, fourth-generation (4G), or greater, mobile network, High Speed Download Packet Access (HSDPA), High Speed Uplink Packet Access (HSUPA), Long-Term Evolution (LTE), Worldwide Interoperability for Microwave Access (WiMax) or any other suitable protocol. In yet another embodiment, the network 150 includes Bluetooth communication networks or a cellular communications network for sending and receiving data such as via short messaging service (SMS), multimedia messaging service (MMS), hypertext transfer protocol (HTTP), direct data connection, wireless application protocol (WAP), email or other types of data known in the art.

FIG. 2 is a block diagram of one embodiment of a sensor data distribution server 130. In the embodiment shown by FIG. 2, the sensor data distribution server 130 includes a processor 210, a storage device 220, an input device 230, a display device 240, an output device 250 and a communication unit 260. The components of the sensor data distribution server 130 are coupled together via a bus 205. However, in different embodiments, the sensor data distribution server 130 may include different and/or additional components than those illustrated by FIG. 2.

The processor 210 processes data or instructions and may comprise various computing architectures. For example, the processor 210 processes data or instructions using a complex instruction set computer (CISC) architecture, a reduced instruction set computer (RISC) architecture, an architecture implementing a combination of instruction sets or any other suitable instruction set. Although FIG. 2 shows a single processor 210, in other embodiments, the sensor data distribution server 130 may include multiple processors. The processor 210 transmits, processes and/or retrieves data from the storage device 220, the input device 230, the display device 240, the output device 250 and the communication unit 260.

The storage device 220 stores data and/or instructions that, when executed by the processor 210, cause the processor 210 to perform one or more actions or to provide one or more types of functionality. The data and/or instructions included in the storage device 220 may comprise computer-readable code that, when executed by the processor 210, performs one or more of the methods described herein and/or provides at least a subset of the functionality described herein. The storage device 220 may comprise a dynamic random access memory (DRAM), a static random access memory (SRAM), a hard disk, an optical storage device, a magnetic storage device, a Read Only Memory (ROM), a Programmable Read Only Memory (PROM), an Erasable Programmable Read Only Memory (EPROM), an Electrically Erasable Programmable Read Only Memory (EEPROM), a Flash memory or another memory device known in the art. The storage device 220 may be a persistent storage device, a non-persistent storage device or a combination of a persistent storage device and a non-persistent storage device, in various embodiments. The storage device 220 is coupled to the processor 210, the input device 230, the display device 240, the output device 250 and/or the communication unit 260 via the bus 205.

In the embodiment shown by FIG. 2, the storage device 220 includes a sensor data store 222, a data exchange store 224, a sensor data distributor 226 and a sensor data analytics engine 228. In other embodiments, the storage device 220 may include different and/or additional components than those shown in FIG. 2. The sensor data store 222 includes data received from the sensor network 120. In one embodiment, the sensor data store 222 associates data from the sensor network 120 with an account identifier and/or a location identifier. For example, the sensor data store 222 is a database associating an account identifier and/or a location identifier with data received from the sensor network 120. Examples of data included in the sensor data store 222 include data describing the frequency with which an item at the location is used, data describing power consumption by an item at the location, data describing power efficiency of an item, data identifying one or more attributes of the item or other data describing usage or properties of items at the location. In one embodiment, the sensor data store 222 includes additional information associated with an account or a location associated with the sensor network 120. For example, the sensor data store 222 includes a description of the location associated with the sensor network 120, a type associated with one or more items at the location associated with the sensor network 120, aesthetic information or preferences associated with the location associated with the sensor network 120, items previously acquired for the location associated with the sensor network 120 or any other suitable data.

The data exchange store 224 includes one or more sensor data distribution settings associated with the account identifier or location identifier. A sensor data distribution setting associates a server 140 with a subset of the sensor data in the sensor data store 222. For example, a sensor data distribution setting associates one or more sensor identifiers with a server 140, associates sensor network data captured during a time interval with a server 140 or associates sensor network data captured from sensors associated with a region with a server 140. Thus, a sensor data distribution setting regulates transmission of stored sensor network data by the sensor data distribution server 130. For example, a sensor data distribution setting prevents transmission of data received from a subset of sensors in the sensor network 120 to a server 140 while allowing transmission of data received from a second subset of sensors in the sensor network 120 to the server 140. As another example, a sensor data distribution setting allows transmission of data received from sensors associated with a first region of the location to a server 140 while preventing transmission of data received from sensors associated with a second region of the location to the server 140. Additional examples of sensor data distribution settings transmit sensor network data captured during a first time interval to a first server 140A and transmit sensor network data captured during a second time interval to a second server 140N. Thus, data stored by the data exchange store 224 allows selection of a subset of sensor network data transmitted from the sensor data distribution server 130 to one or more servers 140A, 140N and/or additional components.

In one embodiment, the data exchange store 224 also includes one or more data exchange settings describing data or content the account or location associated with the sensor network 120 receives from a server 140 responsive to the server 140 receiving sensor network data. For example, a data exchange setting identifies one or more incentives received by a client device 110 associated with the account or location from a server 140 responsive to the server 140 receiving data from the sensor network 120 associated with the account or location. In one embodiment, a data exchange setting identifies the server 140, content or data from the server 140 and sensor data for transmission to the server 140. In one embodiment, the content or data transmitted from the server 140 to a client device 110 associated with the account is proportional to the amount of sensor network data transmitted to the server 140. A data exchange setting may be received from a server 140 or from a client device 110, and data received from a client device 110 may modify the data exchange setting.

The sensor data distributor 226 is data that, when executed by the processor 210, selects a subset of sensor data from the sensor data store 222 for transmission to a server 140 based on a sensor data distribution setting in the data exchange store 224. The sensor data distributor 226 selects a subset of the sensor network data from the sensor data store 222 having one or more attributes specified by a sensor data distribution setting from the data exchange store 224. For example, the sensor data distributor 226 selects sensor data captured by the sensor network 120 during a time interval specified by a sensor data distribution setting and transmits the selected sensor data to a server 140 specified by the sensor data distribution setting. As another example, the sensor data distributor 226 selects sensor data captured from a region in the location by the sensor network 120 specified by a sensor data distribution setting and transmits the selected sensor data to a server 140 specified by the sensor data distribution setting. In an additional example, the sensor data distributor 226 transmits a subset of sensor network data to a server 140 specified by a sensor data distribution setting at a frequency specified by the sensor data distribution setting. By transmitting a selected subset of the sensor data identified by a sensor data distribution setting to a server 140 identified by the sensor data distribution setting and not transmitting sensor data not included in the selected subset to the server 140 identified by the sensor data distribution setting the sensor data distributor 226 maintains sensor network data privacy.

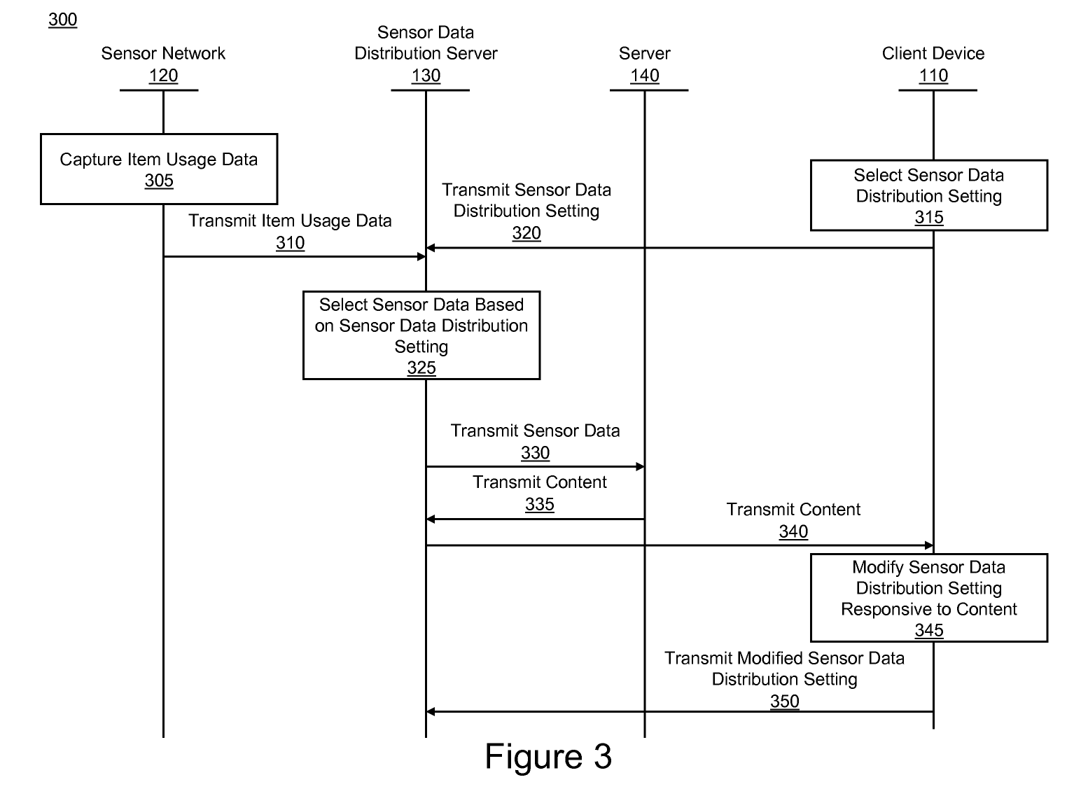

Hence, the sensor data distributor 226 allows a subset of the sensor network data to be pushed from the sensor data distribution server 130 to a server 140 responsive to a sensor data distribution setting. This allows a user of the account or location associated with the sensor network 120 to customize the amount of information a server 140 receives describing item usage at the location associated with the sensor network 120. Operation of the sensor data distributor 226 is further described below in conjunction with FIG. 3.

The sensor data analytics engine 228 comprises instructions that, when executed by the processor 210, generates one or more values from the sensor network data in the sensor data store 222. In one embodiment, the sensor data analytics engine 228 generates a value by applying one or more rules, such as logical operators, to groups of sensor network data in the sensor data store 222. For example, the sensor data distribution server 130 may apply one or more logical operators to sensor network data and store the result. As a more specific example, the sensor data distribution server 130 may generate a value indicating that a region of the location associated with the sensor network 120 is occupied responsive to the sensor data store 222 including two of the following: data indicating a motion sensor associated with the region detects motion, data indicating a radio frequency sensor associated with the region detects a signal or data indicating a sensor associated with an electronic device in the region receives power. In one embodiment, a rule stored, and applied, by the sensor data analytics engine 228 identifies one or more metatags and one or more parameters associated with the metatags; the sensor data analytics engine 228 retrieves sensor network data from the sensor data store 222 and compares parameters associated with the retrieved data to the parameters in the rule. Hence, the sensor data analytics engine 228 combines different sensor network data to generate a value describing additional interactions with items at the location or with the location.

In one embodiment, the sensor data analytics engine 228 generates values from previously stored sensor network data to describe prior interactions with the location or to describe historical trends in item usage or location interaction form the stored sensor network data. For example, the sensor data distribution server 130 retrieves data captured by the sensor network 120 over a specified time interval from the sensor data store 222 and generates one or more values describing changes to the captured data over time, such as a percentage change from the earliest captured data to the most recently captured data, or the average of the captured data over the time interval. Hence, the values generated by the sensor data analytics engine 228 describe usage or items at the location associated with the sensor network 120 or interaction with the location at a more general level than the sensor network data, providing data relevant to the location without identifying the specific data captured by the sensor network 120.

The input device 230 is any device configured to receive input and to communicate the received input to the processor 210, to the storage device 220 or to another component of the sensor data distribution server 130. For example, the input device 230 comprises a cursor controller, a touch-sensitive display or a keyboard. In one embodiment, the input device 230 includes an alphanumeric device, such as a keyboard, a key pad, representations of such created on a touch-sensitive display or another device adapted to communicate information and/or commands to the processor 210 or to the storage device 220.

In another embodiment, the input device 230 comprises a device for communicating positional data as well as data or commands to the processor 210 or to the storage device 220 such as a joystick, a mouse, a trackball, a stylus, a touch-sensitive display, directional keys or another suitable input device known in the art.

The display device 240 is a device that displays electronic images and/or data. For example, the display device 240 comprises an organic light emitting diode display (OLED), a liquid crystal display (LCD) or any other suitable device, such as a monitor. In one embodiment, the display device 240 includes a touch-sensitive transparent panel for receiving data or allowing other interaction with the images and/or data displayed by the display device 240.

The output device 250 comprises one or more devices that convey data or information to a user of the sensor data distribution server 130. For example, the output device 250 includes one or more speakers or headphones for presenting audio data to a user. As another example, the output device 250 includes one or more light emitting diodes (LEDs) or other light sources to provide visual data to a user. As another example, the output device 250 includes one or more devices for providing vibrational, or haptic, feedback to a user. The above are merely examples and the output device 250 may include one or more devices for providing auditory output, tactile output, visual output, any combination of the preceding or any other suitable form of output.

The communication unit 260 transmits data and/or content from the sensor data distribution server 130 to the network 150, a client device 110 and/or to the sensor network 120. The communication unit 260 also receives data from and/or transmits data to a server 140, via the network 150, a client devices 110 and/or a sensor network 120. In one embodiment, the communication unit 260 comprises a wireless transceiver that transmits and/or receives data using one or more wireless communication protocols. For example, the communication unit 260 includes one or more wireless transceivers transmitting and/or receiving data using one or more wireless communication protocols, such as IEEE 802.11 a/b/g/n (WiFi), Global System for Mobile (GSM), Code Division Multiple Access (CDMA), Universal Mobile Telecommunications System (UMTS), General Packet Radio Service (GPRS), second-generation (2G), or greater, mobile network, third-generation (3G), or greater, mobile network, fourth-generation (4G), or greater, mobile network, High Speed Download Packet Access (HSDPA), High Speed Uplink Packet Access (HSUPA), Long-Term Evolution (LTE), Worldwide Interoperability for Microwave Access (WiMax), near field communication (NFC), BLUETOOTH® or another wireless communication protocol. In another embodiment, the communication unit 260 is a network adapter or other type of wired communication port for communicating with the network 150 or with other devices using a wired communication protocol, such as Universal Serial Bus (USB), Ethernet or another suitable wired communication protocol. In yet another embodiment, the communication unit 260 comprises a combination of one or more transceivers and a wired network adapter, or a similar wired device.

In one embodiment, a client device 110 includes components similar to those described above in conjunction with the sensor data distribution server 130 or a subset of the components described above in conjunction with the sensor data distribution server 130. For example, a client device 110 includes a processor 210, a storage device 220, an input device 230, a display device 240, an output device 250 and communication unit 260 coupled together via a bus 205.

### Methods

FIG. 3 is an event diagram of a method 300 for transmitting data captured by a sensor network 120 describing item usage based on one or more sensor data distribution settings in accordance with some embodiments. In the example of FIG. 3, the sensor network 120 is associated with a location and with an account. One or more sensors, or a processor, included in the sensor network 120 include data identifying the account, such as an account identifier, and data identifying the location, such as a location identifier.

The sensor network 120 captures 305 data describing use of items at the location associated with the sensor network 120 and/or data describing one or more attributes of the location. For example, the sensor network 120 captures 305 data describing the frequency with which an item is used, power consumption by the item, power efficiency of the item, item health and/or additional sensors capturing or calculating any suitable metric of item usage or resource usage by an item. In one embodiment, the sensor network 120 also captures 305 data describing an item. For example, the sensor network 120 captures 305 data identifying the item from a barcode associated with the item, a radio frequency identification tag attached to the item, a near field communication transceiver associated with the item or any other suitable source of information identifying and/or describing the item. In one embodiment, the sensor network 120 captures 305 data describing the location, such as a temperature, a time or other data describing one or more attributes of the location.

The sensor network 120 transmits 310 the captured data describing item usage, item properties and/or location data to the sensor data distribution server 130, which stores the sensor network data in a sensor data store 222. For example, a processor included in the sensor network 120 generates a message including data captured 305 by one or more sensors and the account identifier and/or the location identifier and transmits 310 the message to the sensor data distribution server 130. In one embodiment, the sensor network 120 may transmit 310 additional data to the sensor data distribution server 130. For example, the sensor network 120 transmits 310 a description or attributes of one or more items at the location associated with the sensor network 120 in addition to the data describing usage of and/or resources used by the items. In one embodiment, the sensor network 120 transmits 310 the data using a network 150. Alternatively, the sensor network 120 transmits 310 the data using a direct connection between the sensor network 120 and the sensor data distribution server 130.

A client device 110 receives one or more inputs selecting 315 a sensor data distribution setting. In one embodiment, the sensor data distribution server 130 transmits a web page, or other data, describing sensor data distribution settings to the client device 110, which receives one or more inputs selecting 315 a sensor data distribution setting from the data. The sensor data distribution setting associates a server 140 with a subset of the data from the sensor network 120. For example, a sensor data distribution setting associates one or more sensor identifiers with a server 140, associates sensor network data captured during a time interval with a server 140 or associates sensor network data captured from sensors associated with a region of the location with a server 140. Thus, a sensor data distribution setting regulates transmission of stored sensor network data by the sensor data distribution server 130. For example, a sensor data distribution setting may prevent transmission of data received from a subset of sensors from the sensor network 120 to a server 140 while allowing transmission of data received from a second subset of sensors from the sensor network 120 to the server 140.

In one embodiment data describing the sensor data distribution setting presented by the client device 110 may also identify content received from a server 140 in response to receiving the sensor network data. For example, the sensor data distribution server 130 transmits data from a data exchange store 224 describing content transmitted by a server 140 in response to receiving an amount or a type of sensor network data. This allows a user associated with the account to identify potential benefits or content available from a server 140 when selecting 315 the sensor data distribution setting.

The sensor data distribution setting is transmitted 320 from the client device 110 to the sensor data distribution server 130 via the network 150 or via a direct connection between the sensor data distribution server 130 and the client device 110. The sensor data distribution server 130 stores the received sensor data distribution setting in a data exchange store 224. Based on the sensor data distribution setting, the sensor data distribution server 130 selects a subset of sensor network data. In one embodiment, a sensor data distributor 226 in the sensor data distribution server 130 selects 325 sensor data having one or more attributes identified by the sensor data distribution setting from the sensor data store 222 and transmits 330 the selected sensor data to a server 140 identified by the sensor data distribution setting via the network 150. For example, the sensor data distribution setting identifies sensor network data associated with a region within the location for transmission to a server 140; the sensor data distributor 226 selects 325 a subset of sensor data associated with the identified region and the sensor data distribution server 130 transmits 330 the subset to the server 140 identified by the sensor data distribution setting.

In one embodiment, the subset of the sensor network data includes one or more values generated from the sensor network data by the sensor data analytics engine 228. For example, the subset of the sensor network data includes data describing historical data captured by sensors associated with a specified metatag or includes values generated by application of one or more logical operators to data captured by different sensors included in the sensor network 120. In one embodiment, the subset of the sensor network data comprises values generated by the sensor data analytics engine 228 instead of sensor network data, allowing the sensor network data itself to remain private while the generated values provide information about usage of items at the location or about the location.

While the sensor data distribution server 130 transmits 330 the subset of sensor data identified by the sensor data distribution setting, stored sensor data not included in the subset is not transmitted 330 to the server 140. This allows a user to limit the transmission of sensor network data to a server 140, maintaining the privacy of sensor network data. Hence, the sensor data distribution setting allows a user to stop transmission of sensor network data, preventing a particular server 140 or multiple servers 140 from receiving sensor network data and/or otherwise regulating distribution of sensor network data captured by the sensor network 120.

In one embodiment, the server 140 transmits 335 content to the sensor data distribution server 130 responsive to receiving the subset of the sensor network data from the sensor data distribution server 130. The sensor data distribution server 130 transmits 340 the content to the client device 110. For example, the server 140 compares attributes of the subset of the sensor network data received from the sensor data distribution server 130 to attributes stored by the server 140 and transmits 335 content to the sensor data distribution server 130 responsive to one or more attributes of the subset matching one or more attributes stored by the server 140. For example, the server 140 transmits 335 content to the sensor data distribution server 130 responsive to the subset including one or more metatags matching one or more requested metatags stored by the server 140. Thus, the account associated with the sensor network 120 receives content or another benefit in exchange for transmitting 330 a subset of the sensor network data to a server 140. For example, responsive to the server 140 receiving a subset of the sensor network data including data captured during a specified time interval, the server 140 transmits 335 a dozen coupons for products provided by the third-party associated with the server 140 to sensor data distribution server 130, which transmits 340 the coupons to the client device 110.

In an alternative embodiment, the server 140 uses different methods to provide content to the account associated with the sensor network 120. For example, a provider associated with the server 140 may mail physical coupons or other items to an address associated with the account responsive to the server 140 receiving sensor network data having an attribute matching an attribute stored by the server 140. As another example, a provider associated with the server 140 may call a telephone number associated with the account to provide the account with content in response to receiving a subset of the sensor data matching one or more attributes stored by the server 140.

In one embodiment, the content transmitted to the client device 110 also identifies additional content available for transmission to the client device 110 responsive to the server 140 receiving additional and/or different sensor network data. For example, the client device receives a message indicating that an additional ten coupons would be transmitted 140 to the client device 110 if the server 140 receives sensor network data captured during a longer time interval, captured during an additional time interval, captured by sensors associated with a specified metatag or captured from a particular region of the location. This allows the server 140 to provide an incentive to the account associated with the sensor network 120 in exchange for selecting 315 additional sensor network data for transmission to the server 140, providing a benefit for the account in exchange for transmitting additional sensor network data to the server 140.

The client device 110 may receive an input modifying 345 the sensor data distribution setting responsive to the content received from the server 140. For example, responsive to an indication that increased content may be transmitted to the client device 110 responsive to the server 140 receiving an increased amount of sensor network data, the client device 110 receives an input modifying 345 the synchronization data distribution setting to increase the size of the subset of sensor network data transmitted 310 to the server 140 or to identify a second subset of sensor network data transmitted 310 to the server 140. As another example, responsive to an indication that additional content may be transmitted to the client device 110 responsive to a second server 140 receiving sensor network data, the client device 110 receives an input modifying 345 the synchronization data distribution setting, or selecting 315 a second synchronization data distribution setting, to identify a second subset of the sensor network data for transmission to the second server 140. The modified sensor data distribution setting is transmitted 350 to the sensor data distribution server 130, which stores it in the data exchange store 224. This allows the sensor data distribution server 130 to subsequently modify the subset of sensor network data transmitted to the server 140 using the modified sensor data distribution setting, enabling dynamic modification of the transmitted sensor network data based on the modified sensor data distribution setting.

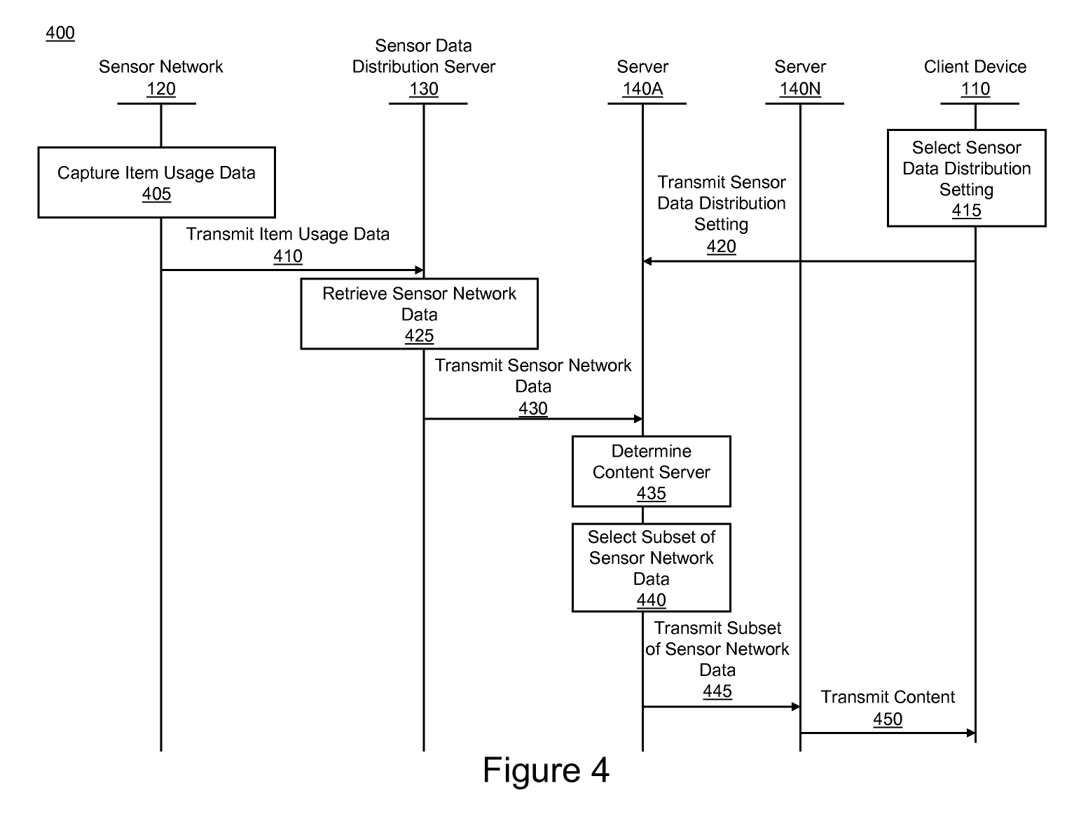

FIG. 4 is an event diagram of an alternative method 400 for transmitting data captured by a sensor network 120 describing item usage based on one or more sensor data distribution settings in accordance with some embodiments. In the example of FIG. 4, the sensor network 120 is associated with a location and with an account. One or more sensors, or a processor, included in the sensor network 120 include data identifying the account, such as an account identifier, and data identifying the location, such as a location identifier.

The sensor network 120 captures 405 data describing use of items at the location associated with the sensor network 120 and/or data describing one or more attributes of the location and transmits 410 the captured data to a sensor data distribution server 130, as described above in conjunction with FIG. 3. The sensor data distribution server 130 stores the sensor network data in a sensor data store 222.

A client device 110 receives one or more inputs selecting 415 a sensor data distribution setting. In one embodiment, the sensor data distribution server 130 transmits a web page, or other data, describing sensor data distribution settings to the client device 110, which receives one or more inputs selecting 415 a sensor data distribution setting from the data. The sensor data distribution setting associates a server 140N with a subset of the data from the sensor network 120. For example, a sensor data distribution setting associates one or more sensor identifiers or metatags with a server 140N, associates sensor network data captured during between a starting time and an ending time with a server 140N or associates sensor network data captured from sensors associated with a region of the location with a server 140N. The sensor data distribution setting is further described above in conjunction with FIGS. 1-3.

The sensor data distribution setting is transmitted 420 from the client device 110 to a liaison server 140A, along with an account identifier or a location identifier, via the network 150. The liaison server 140A stores the received sensor data distribution setting. In one embodiment, the liaison server 140A stores the received sensor data distribution setting and associates the sensor data distribution setting with the account identifier or the location identifier.

A sensor data distributor 226 in the sensor data distribution server 130 retrieves 425 sensor data from the sensor data store 222 and transmits 430 the sensor network data to the liaison server 140A via the network 150. In one embodiment, the sensor data distributor 226 transmits 430 an account identifier or a location identifier associated with the sensor network 120 in addition to the sensor network data. The liaison server 140A determines a sensor data distribution setting associated with the received sensor network data and determines a content server 140N from the sensor data distribution setting. For example, the liaison server 140A identifies a sensor data distribution setting associated with an account identifier matching the account identifier received from the sensor data distribution server 130. From the identified sensor data distribution setting, the liaison server 140A determines 435 a content server 435 and selects 440 a subset of the sensor network data. For example, the liaison server 140A selects 440 a subset of the sensor network data including one or more metatags, or other attributes, matching one or more metatags, or attributes, included in the sensor data distribution setting associated with the content server 140N.

The liaison server 140A transmits 445 the subset of sensor network data to the content server 140N associated with the sensor data distribution setting via the network 150. While the liaison server 140A transmits 445 the subset of sensor data identified by the sensor data distribution setting, sensor network data not included in the subset is not transmitted 445 to the content server 140N. This allows the sensor data distribution setting to limit the sensor network data transmitted 445 to a content server 140, maintaining the privacy of sensor network data. Additionally, different sensor data distribution settings may be used by the liaison server 140A to transmit different subsets of sensor network data to different content servers 140, customizing the data transmitted 445 to various content servers 140.

In one embodiment, the content server 140N transmits 450 content to the client device 110 responsive to receiving the subset of the sensor network data from the liaison server 140A. For example, the content server 140N compares attributes of the subset of the sensor network data received from the liaison server 140A to attributes stored by the content server 140N and transmits 450 content to the sensor data distribution server 130 responsive to one or more attributes of the subset matching one or more attributes stored by the server 140. For example, the content server 140N transmits 450 content to the client device 110 responsive to the subset including one or more metatags matching one or more requested metatags stored by the content server 140A. For example, responsive to the content server 140N receiving a subset of the sensor network data including data captured during a specified time interval, the content server 140N transmits 450 a dozen coupons for products provided by the third-party associated with the content server 140N to the client device 110.

In an alternative embodiment, the content server 140N uses different methods to transmit 450 content to the account associated with the sensor network 120. For example, a provider associated with the content server 140N may mail physical coupons or other items to an address associated with the account responsive to the content server 140N receiving sensor network data having one or more attributes, such as metadata. As another example, a provider associated with the content server 140N may call a telephone number associated with the account to provide the account with content in response to receiving a subset of the sensor data matching one or more attributes stored by the content server 140N.

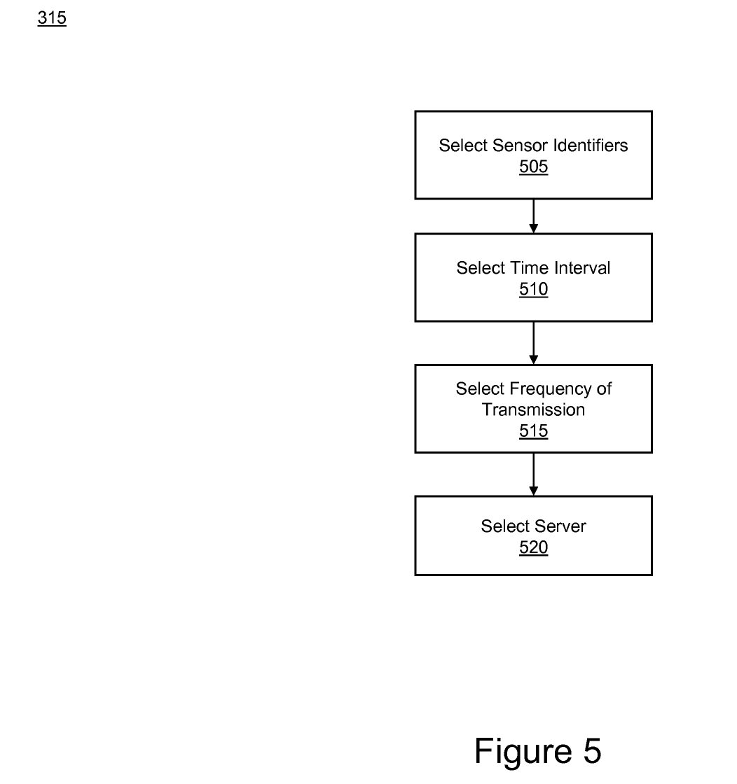

FIG. 5 is a flow chart of a method for selecting 315 a sensor data distribution setting to identify sensor network data for transmission to a server 140. In one embodiment, the steps illustrated by the method shown by FIG. 5 are implemented by instructions for performing the described actions embodied, or stored, within a non-transitory computer readable storage medium included in a client device 110 that, when executed by a processor, provide the functionality further described below. Examples of a non-transitory computer readable storage medium, such as the storage device 220, include flash memory, random access memory (RAM) or any other suitable medium known to one skilled in the art.

The method may be implemented in embodiments of hardware, software or combinations of hardware and software. In one embodiment, instructions for performing the actions described below are stored in a storage device of a client device 110. Alternatively, instructions for performing the actions described below are stored in the storage device 220 of the sensor data distribution server 130, such as in the sensor data distributor 226, and are transmitted to the client device 110 for execution by a processor included in the client device 110 to perform the actions described below. Moreover, in some embodiments, the method includes different and/or additional steps than those shown by FIG. 5. In other embodiments, the method may include fewer steps than those shown by FIG. 5.

In one embodiment, sensor identifiers are selected 505 to identify a sensor or sensors capturing the subset of data associated with a sensor data distribution setting. For example, sensor identifiers associated with a region of the location associated with the sensor network 120 are selected 505 so the sensor data distribution setting includes data captured in the region of the location. As another example, sensor identifiers associated with a type of sensor are selected 505 so the sensor data distribution setting includes data from a type of sensor.

A time interval may also be selected 510 and associated with the sensor identifiers. The time interval specifies a range of time during which data captured by the sensors corresponding to the selected sensor identifiers is associated with the sensor data distribution setting. For example, a selected time interval specifies that data captured by the selected sensors between 5:00 PM and 8:00 PM is associated with the sensor data distribution setting. This allows a user to limit the amount of sensor data associated with the sensor data distribution setting. In one embodiment, a frequency of transmission is also selected 515 to indicate how often sensor network data associated with the sensor data distribution setting is transmitted to a server 140. For example, the frequency of transmission indicates that sensor network data associated with the sensor data distribution setting is transmitted to a server 140 at a 12-hour interval, at a 24-hour interval, at a weekly interval or at another time interval.

One or more servers 140 are selected 520 and associated with the selected sensor identifiers to specify a destination for data captured by the selected sensors. This beneficially allows a user of the account associated with the sensor network 120 to limit distribution of the captured sensor network data to an identified server 140 or servers 140. Hence, selection 315 of a sensor data distribution setting customizes transmission of sensor network data. For example, a sensor data distribution setting limits the sensors from which captured data is transmitted, limits the server 140 receiving data from the selected sensors, limits the amount of data captured by the selected sensors that is transmitted or limits the frequency with which the data captured by the selected sensors is transmitted to an identified server.

While FIG. 5 illustrates an embodiment of the method 500 where different elements are selected in different steps, in some embodiments multiple elements may be selected in a single step. For example, a client device 110 may receive a message from a server 140 requesting data captured by a sensor network 120 associated with an account that is also associated with the client device 110. The message, or data associated with the message, may identify the server 140, a starting time, an ending time and one or more metatags identifying the sensor network data requested by the server 140. Responding to the message or accessing a portion of the message may automatically generate a sensor data distribution setting, simplifying specification of a sensor data distributions setting associated with the server 140.

In the foregoing specification, specific embodiments have been described. However, one of ordinary skill in the art appreciates that various modifications and changes can be made without departing from the scope of the invention as set forth in the claims below. Accordingly, the specification and Figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment may be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions, programs, and/or integrated circuits with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
receiving, from a sensor network, data describing usage of one or more items at a location associated with the sensor network;
receiving a sensor data distribution setting identifying a subset of the data from the sensor network data and a server associated with the subset; and
responsive to the sensor data distribution setting, transmitting the subset of data to the server associated with the subset without transmitting data from the sensor network data not included in the subset.

2. The method of claim 1, wherein the subset of the data from the sensor network data comprises data captured from one or more sensors associated with a first metatag.

3. The method of claim 1, wherein the subset of the data from the sensor network data comprises data captured from one or more sensors included in a region of the location.

4. The method of claim 1, wherein the subset of the data from the sensor network data comprises data captured by the sensor network between a first time and a second time.

5. The method of claim 1, wherein the subset of the data from the sensor network data comprises data captured from a specified type of sensor included in the sensor network.

6. The method of claim 1, further comprising:
receiving content from the server responsive to the server receiving the subset of data; and
transmitting the content to a client device.

7. The method of claim 6, wherein responsive to the server receiving the subset of data comprises:
responsive to the subset of data including data associated with one or more attributes identified by the server.

8. The method of claim 1, wherein transmitting the subset of data to the server associated with the subset without transmitting data from the sensor network data not included in the subset comprises:
selecting sensor network data having an attribute matching an attribute included in the sensor data distribution setting; and
transmitting the sensor network data having the attribute matching the attribute included in the sensor data distribution setting to the server.

9. The method of claim 8, wherein the attributes comprise at least one metatag.

10. The method of claim 1, wherein the subset of the data from the sensor network data comprises a value generated from applying a rule to data captured by a plurality of sensors in the sensor network.

11. A system comprising:
a sensor network associated with a location and with an account, the sensor network capturing data describing usage of one or more items at the location; and
a sensor data distribution server coupled to the sensor network, the sensor data distribution server configured to receive data describing usage of one or more items at the location from the sensor network and to select a subset of the data from the sensor network data based on a sensor data distribution setting and to transmit the subset of the data from the sensor network data to a server identified by the sensor data distribution setting without transmitting data from the sensor network data not in the subset.

12. The system of claim 11, wherein:
the sensor data distribution server is further configured to receive content from the server responsive to the server receiving the subset of data.

13. The system of claim 12, further comprising:
a client device coupled to the sensor data distribution server, the client device configured to receive the content.

14. The system of claim 12, wherein the content received from the server is proportional to the amount of data in the subset of the data from the sensor network.

15. The method of claim 12, wherein responsive to the server receiving the subset of data comprises:
responsive to the subset of data including data associated with one or more attributes identified by the server.

16. The system of claim 12, wherein the content received from the server includes an indication of additional content data for transmission by the server responsive to the server receiving additional sensor network data.

17. The system of claim 11, further comprising:
a client device coupled to the sensor data distribution server, the client device configured to select the sensor data distribution setting and to transmit the sensor data distribution setting to the sensor data distribution server.

18. The system of claim 11, wherein the subset of the data from the sensor network data comprises data captured from one or more sensors associated with a first metatag.

19. The system of claim 11, wherein the subset of the data from the sensor network data comprises data captured by the sensor network between a first time and a second time.

20. A method comprising:
selecting a sensor identifier associated with a sensor included in a sensor network associated with a location;
associating a server with the sensor identifier;
generating a sensor data distribution setting including the sensor identifier and the server; and
transmitting the sensor data distribution setting to a sensor data distribution server, the sensor data distribution server identifying a subset of data from the sensor network based on the sensor data distribution setting.

21. The method of claim 20, wherein generating the sensor data distribution setting including the sensor identifier and the server comprises:
selecting a first time and a second time associated with the sensor identifier, where data captured by the sensor associated with the sensor identifier between the first time and the second time is associated with the server.

22. The method of claim 20, wherein generating the sensor data distribution setting including the sensor identifier and the server comprises:
selecting a frequency of transmission associated with the sensor identifier, the time interval describing a frequency with which data captured by the sensor identifier is transmitted to the server.

23. The method of claim 20, wherein selecting the sensor identifier associated with the sensor included in the sensor network associated with the location comprises:
selecting one or more sensors associated with a first metatag.
